(19) United States
(12) Patent Application Publication
(10) Pub. No.: US 2023/0004603 A1
(43) Pub. Date: Jan. 5, 2023

(54) MACHINE LEARNING (ML) MODEL FOR GENERATING SEARCH STRINGS

(71) Applicants: Ujjwal Kapoor, Delhi (IN); Rajesh Kapoor, Delhi (IN)

(72) Inventors: Ujjwal Kapoor, Delhi (IN); Rajesh Kapoor, Delhi (IN)

(21) Appl. No.: 17/646,493

(22) Filed: Dec. 30, 2021

(30) Foreign Application Priority Data
Jul. 5, 2021 (IN) 202111030203

(51) Int. Cl. G06F 16/903; G06F 16/9032

(52) U.S. Cl. CPC G06F 16/90344; G06F 16/90332

(57) ABSTRACT

Embodiments illustrated herein disclose a method includes receiving a text input, wherein the text input corresponds to a search string. The method further includes converting the text input to a string vector. Additionally, method further includes retrieve, by the processor, one or more phrases in the text input. Further, the method includes predicting one or more technology classifications associated with the text input based on the string vector by utilizing a Machine Learning (ML) model. The method includes generating at least a first structured search string based on the one or more technology classifications and the one or more phrases.

### CROSS-RELATED APPLICATIONS

This application claims priority of Indian Application No. 202111030203, filed Jul. 5, 2021, the contents of which are incorporated herein by reference.

### TECHNICAL FIELD

The presently disclosed embodiments are related, in general, to searching a database. More particularly, the presently disclosed embodiments are related to a ML model for generating a structured search string to search through the database.

### BACKGROUND

Databases, in general, are configured to store content/information in a predetermined format and/or structure. For example, a patent database may be configured to store information pertaining to one or more patents and/or patent applications in a predetermined structure. For instance, the structure of the patent database may include, but not limited to a bibliographic detail pertaining to the one or more patents and/or patent applications, claims of the one or more patents and/or patent applications, and/or specification of the one or more patents and/or patent applications. Searching through such database may require formulation of a structured search string based on which the database may be queried to retrieve the requisite information.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and method to generate ML model for capable of generating a search string is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

FIG. 1 is a block diagram that illustrates a system environment, in accordance with an embodiment of the disclosure;

FIG. 2 is a block diagram of a central server, in accordance with an embodiment of the disclosure;

FIG. 3 is a diagram that illustrates an exemplary scenario of generating a first structured search string, in accordance with an embodiment of the disclosure;

FIG. 4 is a diagram of another exemplary scenario of generating a second structured search string and a third structured search string, in accordance with an embodiment of the disclosure; and

FIG. 5 is a flowchart illustrating a method for generating a search strategy, in accordance with an embodiment of the disclosure;

FIG. 6 is a block diagram of a computing device, in accordance with an embodiment of the disclosure; and

FIG. 7 is a flowchart illustrating a method for generating a search strategy, in accordance with an embodiment of the disclosure.

### DETAILED DESCRIPTION

The illustrated embodiments describe a method includes receiving a text input, wherein the text input corresponds to a search string. The method further includes converting the text input to a string vector. Additionally, method further includes retrieve, by the processor, one or more phrases in the text input. Further, the method includes predicting one or more technology classifications associated with the text input based on the string vector by utilizing a Machine Learning (ML) model. The method includes generating at least a first structured search string based on the one or more technology classifications and the one or more phrases.

The various embodiments describe a central server that includes a memory device storing a set of instructions. A processor communicatively coupled to the memory device. The processor is configured to execute the set of instructions to receive a text input, wherein the text input corresponds to a search string. Further, the processor is configured to convert the text input to a string vector. Additionally, the processor is configured to retrieve one or more phrases in the text input. Furthermore, the processor is configured to predict one or more technology classifications associated with the text input based on the string vector by utilizing a Machine Learning (ML) model. Furthermore, the processor is configured to generate at least a first structured search string based on the one or more technology classifications and the one or more phrases.

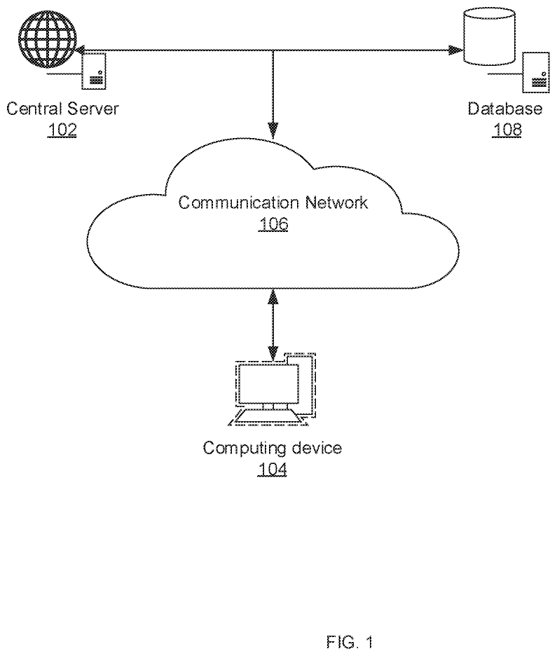

FIG. 1 is a block diagram that illustrates a system environment for training a ML model, in accordance with an embodiment of the disclosure. Referring to FIG. 1, there is shown a system environment 100, which includes a central server 102, a computing device 104, a communication network 106, and a database 108. The central server 102, the computing device 104, and the database 108 may be communicatively coupled with each other through the communication network 106.

The central server 102 may comprise suitable logic, circuitry, interfaces, and/or code that may be configured to retrieve information from the database 108. For example, the central server 102 may be configured to retrieve information pertaining to one or more patents/patent applications from the database 108. Additionally or alternatively, the central server 102 may be configured to receive a search string from the computing device 104. Further, the central server 102 may be configured to convert the search string to a structured search string based on a Machine Learning (ML) model. In an exemplary embodiment, the search string received from the computing device 104 may correspond to information described in a native language. For example, the search string (received from the computing device 104) may include a technical concept for which the one or more patents/patent applications are to be retrieved from the database 108. Further, the technical concept may be described in plain English. In an example embodiment, the structured search string may correspond to a script that includes one or more predetermined fields, and one or more keywords corresponding to the one or more predetermined fields. The one or more predetermined fields may be deterministic based on the structure of the database 108. A person having ordinary skills in the art would appreciate that the database 108 includes one or more fields (that in some examples corresponds to columns of a tuple and/or table in the database) within which the information is stored. In an exemplary embodiment, prior to using the ML model, the central server 102 may be configured to train the ML model using a training data. Examples of the central server 102 may include, but are not limited to, a personal computer, a laptop, a personal digital assistant (PDA), a mobile device, a tablet, or any other computing device.

The computing device 104 may comprise suitable logic, circuitry, interfaces, and/or code that may be configured to receive a user interface (UI) from the central server 102. Through the first UI, the computing device 104 may be configured to receive a text input that may correspond to a search string. Additionally or alternatively, the computing device 104 may be configured to transmit the text input to the central server 102. In an exemplary embodiment, the computing device 104 may receive the structured search string from the central server 102 based on the transmission of the search string. Additionally or alternatively, the computing device 104 may be configured to receive metadata pertaining to the structured search string from the central server 102. In some examples, the metadata pertaining to the structured search string and the structured search string may be presented on the UI. The computing device 104 may be configured to receive another input from the user, through the UI, to modify the structured search string based on the metadata associated with the structured search string. In an alternative embodiment, the computing device 104 may be configured to receive only the metadata associated with the structured search string. In such an embodiment, the computing device 104 may be configured to generate the structured search string based on the metadata associated with the structured search string. Alternatively, the computing device 104 may be configured to generate the structured search string based on the other input from the user and the metadata associated with the search string. The metadata associated with the structured search string and the other input received from the computing device 104 are described later in conjunction with FIGS. 1, 2, 5, and 6. Examples of the computing device 104 may include, but are not limited to, a personal computer, a laptop, a personal digital assistant (PDA), a mobile device, a tablet, or any other computing device.

In an embodiment, the communication network 106 may include a communication medium through which each of the computing device 104 may communicate with the central server 102 and/or database 106. Such a communication may be performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G, 5G, 6G cellular communication protocols, and/or Bluetooth (BT) communication protocols. The communication network 106 may include, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

The database 108 may comprise suitable logic, circuitry, interfaces, and/or code that may be configured to store information in a structured format. In some examples, a type of the information stored in the database 108 may be deterministic based on the application area in which the system environment 100 has been implemented. For example, in patent document search application, the database 108 may be configured to store the one or more patents/patent applications documents. In another example, in job portal application, the database 108 may be configured to store one or more resumes of one or more candidates. In yet another example, in court case law application, the database 108 may be configured to store transcripts of the judgements. The database 108 may be configured to store the information in a structured format. The database 108 may receive a query based on which the database 108 may be configured to retrieve the information. In some examples, the query may correspond to the structured search string. Some examples of the database 108 may include, but not limited to, Mysql®, MongoDB®, and/or the like.

In some examples, the scope of the disclosure is not limited to the database 108 being a separate from the central server 102. In an example embodiment, the database 108 may be implemented on the central server 102.

In operation, the central server 102 may be configured to retrieve raw data from an external database related to the application area. For example, the central server 102 may be configured to retrieve the raw pertaining to the patents/patent applications from the external database. In some examples, the raw data may include information that is distributed/categorized in one or more predetermined fields. For example, the raw data pertaining to the patent/patent applications may include one or more predetermined fields such as, but not limited to, bibliographic details, description, claims, drawings, technology classification, and/or the like. In some examples, the scope of the disclosure is not limited to central server 102 retrieving the raw data pertaining to the patent/patent applications. In an example embodiment, the central server 102 may retrieve the raw data pertaining to any other application areas.

In some examples, the central server 102 may be configured to generate training data from the raw data. For example, the central server 102 may be configured to modify the raw data to generate the training data. For instance, in the application area of the patent/patent applications, the central server 102 may be configured to generate training data that includes only fields description, claims, and technology classification. Thereafter, the central server 102 may be configured to generate the ML model using the training data. In an example embodiment, the training data may define one or more features and one or more labels. The one or more features may correspond to expected input that are provided to the ML model. The one or more labels correspond to expected output of the ML model. In some examples, in the application area of the patent/patent applications, the predetermined fields of description and/or the claims may correspond to the one or more features and the predetermined field of the technology classification may correspond to the label.

For the purpose of ongoing description, the application area has been considered to be patent/patent applications. However, a person having ordinary skills in the art would appreciate that the embodiments described herein are also applicable to various other application areas without departing from the scope of the disclosure.

In an example embodiment, the central server 102 may be configured to train the ML model based on the training data. The trained ML model may be configured to predict the labels based on the one or more features inputted to the ML model. For example, in the application area of the patents/patent applications, the ML model may receive the text input/search string. Based on the text input, the ML model may be utilized to predict the technology classification associated with the text input. Additionally or alternatively, the central server 102 may be configured to generate a vocabulary database during the training of the ML model. The vocabulary database may be configured to include one or more words that are interchangeably used in the patents/patent applications. In some examples, the central server 102 may be configured to utilize the data included in the fields of description and the claims to generate the vocabulary database.

Thereafter, the central server 102 may be configured to receive the text input/search string from the computing device 104. The central server 102 may be configured to predict the technology classification associated with the search string/text input. Additionally or alternatively, the central server 102 may be configured to utilize the vocabulary database determine a set of words for each word, included in the search string. The set of words may correspond to synonyms of the words included in the search string/text input. The central server 102 may be configured to transmit the set of words and the technology classification to the computing device 104. In some examples, the technology classification and the set of words may correspond to the metadata associated with the structured search string.

In an example embodiment, the computing device 104 may be configured to receive the technology classification and the set of words (also referred as the metadata associated with the structured search string) from the central server 102. In response to the reception of the technology classification and the set of words, the computing device 104 may be configured to generate the structured search string. Thereafter, the computing device 104 may be configured to transmit the structured search string to the database 108 as a query to retrieve information corresponding to the structured search string. For example, the computing device 104 may be configured to transmit the structured search string to the database 108 to retrieve one or more patent/patent application documents corresponding to the structured search string.

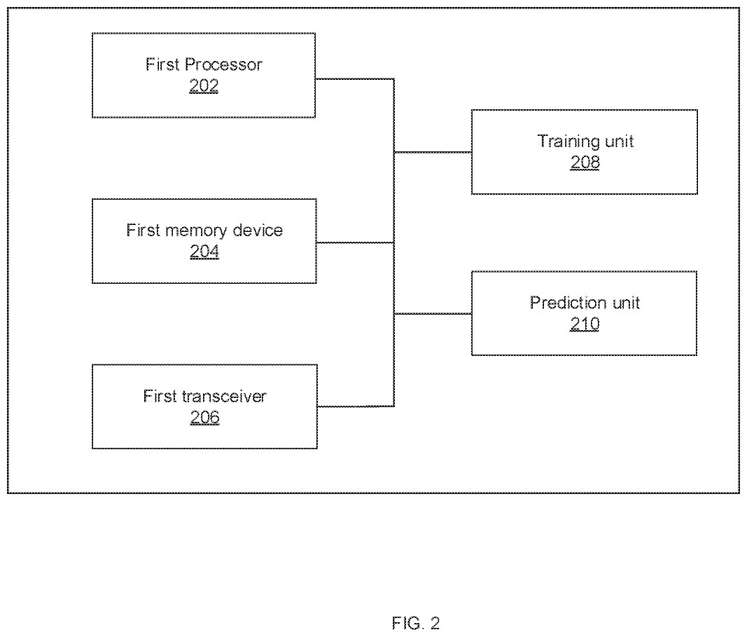

In some examples, the scope of the disclosure is not limited to the computing device 104 generating a single structured search string. In an exemplary embodiment, the computing device 104 may be configured to generate more than one structured search string based on the metadata associated with the structured search string. In yet another exemplary embodiment, the computing device 104 may not generate the structured search string. In such an embodiment, the central server 102 may be configured to generate and transmit the structured search string to the computing device 104. In such an embodiment, the user of the computing device 104 may be configured to modify the structured search string. Further, the computing device 104 may be configured to transmit the modified structured search string to the database 108 to retrieve the one or more patent/patent applications corresponding to the structured search string. The generation and modification of the structured search string is further described in con junction with FIG. 2.

FIG. 2 illustrates a block diagram of a central server 102, according to one or more embodiments illustrated herein. The central server 102 includes a first processor 202, a first memory device 204, a first transceiver 206, a training unit 208, and a prediction unit 210.

The first processor 202 may be embodied as one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit (ASIC) or field programmable gate array (FPGA), or some combination thereof.

Accordingly, although illustrated in FIG. 2 as a single controller, in an exemplary embodiment, the first processor 202 may include a plurality of processors and signal processing modules. The plurality of processors may be embodied on a single computing device or may be distributed across a plurality of computing devices collectively configured to function as the circuitry of the central server 102. The plurality of processors may be in communication with each other and may be collectively configured to perform one or more functionalities of the circuitry of the central server 102, as described herein. In an exemplary embodiment, the first processor 202 may be configured to execute instructions stored in the first memory device 204 or otherwise accessible to the first processor 202. These instructions, when executed by the first processor 202, may cause the circuitry of the central server 102 to perform one or more of the functionalities, as described herein.

Whether configured by hardware, firmware/software methods, or by a combination thereof, the first processor 202 may include an entity capable of performing operations according to embodiments of the present disclosure while configured accordingly. Thus, for example, when the first processor 202 is embodied as an ASIC, FPGA or the like, the first processor 202 may include specifically configured hardware for conducting one or more operations described herein. Alternatively, as another example, when the first processor 202 is embodied as an executor of instructions, such as may be stored in the first memory device 204, the instructions may specifically configure the first processor 202 to perform one or more algorithms and operations described herein.

Thus, the first processor 202 used herein may refer to a programmable microprocessor, microcomputer or multiple processor chip or chips that may be configured by software instructions (applications) to perform a variety of functions, including the functions of the various embodiments described above. In some devices, multiple processors may be provided that may be dedicated to wireless communication functions and one processor may be dedicated to running other applications. Software applications may be stored in the internal memory before they are accessed and loaded into the processors. The processors may include internal memory sufficient to store the application software instructions. In many devices, the internal memory may be a volatile or nonvolatile memory, such as flash memory, or a mixture of both. The memory can also be located internal to another computing resource (e.g., enabling computer readable instructions to be downloaded over the Internet or another wired or wireless connection).

The first memory device 204 may include suitable logic, circuitry, and/or interfaces that are adapted to store a set of instructions that is executable by the first processor 202 to perform predetermined operations. Some of the commonly known memory implementations include, but are not limited to, a hard disk, random access memory, cache memory, read only memory (ROM), erasable programmable read-only memory (EPROM) & electrically erasable programmable read-only memory (EEPROM), flash memory, magnetic cassettes, magnetic tape, magnetic disk storage or other magnetic storage devices, a compact disc read only memory (CD-ROM), digital versatile disc read only memory (DVD-ROM), an optical disc, circuitry configured to store information, or some combination thereof. In an exemplary embodiment, the first memory device 204 may be integrated with the first processor 202 on a single chip, without departing from the scope of the disclosure.

The first transceiver 206 may correspond to a communication interface that may facilitate transmission and reception of messages and data to and from various devices (e.g., computing device 104). Examples of the first transceiver 206 may include, but are not limited to, an antenna, an Ethernet port, a USB port, a serial port, or any other port that can be adapted to receive and transmit data. The first transceiver 206 transmits and receives data and/or messages in accordance with the various communication protocols, such as, Bluetooth®, Infra-Red, I2C, TCP/IP, UDP, and 2G, 3G, 4G or 5G communication protocols.

The training unit 208 may include suitable logic and/or circuitry that may enable the training unit 208 to generate the training data based on raw data retrieved from the database 108. Further, the training unit 208 may be configured to train the ML model based on the training data. In an example embodiment, the training unit 208 may utilize known technologies such as, but are not limited to, logistic regression, Bayesian regression, random forest regression, and/or the like, to train the ML model. As discussed, the ML model may be configured to predict the technology classification associated with the text input. Additionally, the training unit 208 may be configured to generate the vocabulary database that may include one or more words that are interchangeably used in the patents/patent applications. The training unit 208 may be implemented using Field Programmable Gate array (FPGA) and/or Application Specific Integrated Circuit (ASIC).

The prediction unit 210 may include suitable logic and/or circuitry that may enable the prediction unit 210 to receive the text input from the computing device 104. Based on the text input and the ML model (trained by the training unit 208), the prediction unit 210 may be configured to predict the technology classification associated with the text. Additionally, the prediction unit 210 may be configured to retrieve one or more phrases from the text input. Additionally or alternatively, the prediction unit 210 may be configured to determine one or more additional phrases that correspond to the one or more phrases. For example, the prediction unit 210 may be configured to determine one or more synonyms of the one or more phrases as the one or more additional phrases. Thereafter, the prediction unit 210 may be configured to generate the structured search string based on the one or more phrases, the one or more additional phrases and the technology classification. In an alternative embodiment, the prediction unit 210 may be configured to transmit the one or more phrases, the one or more additional phrases and the technology classification to the computing device 104. In response to the transmission of the one or more phrases, the one or more additional phrases and the technology classification, the prediction unit 210 may receive a selection input from the user. In an example embodiment, the selection input may correspond to the selection of a set of phrases, a set of additional phrases, and the technology classification, of the one or more phrases, the one or more additional phrases, and the technology classification, respectively. Thereafter, the prediction unit 210 may be configured to generate the structured search string based on the selection input. In yet another alternative embodiment, the prediction unit 210 may not generate the structured search string. In such an embodiment, the computing device 104 may be configured to generate the structured search string based on the one or more phrases, the one or more additional phrases and the technology classification (received from the central server 102). The prediction unit 210 may be implemented using Field Programmable Gate array (FPGA) and/or Application Specific Integrated Circuit (ASIC).

In operation, the training unit 208 may be configured to retrieve the raw data from the database 108. As discussed, the raw data pertaining to the patent/patent applications may include one or more predetermined fields such as, but not limited to, bibliographic details, description, claims, drawings, technology classification, and/or the like. Thereafter, the training unit 208 may be configured to clean the raw data. For example, the training unit 208 may be configured to generate an intermediate data that includes a set of fields of the one or more fields. For example, the intermediate data (retrieved from the raw data pertaining to the patent/patent applications field) may include the claims, description, and the technology classification. Following table illustrates an example intermediate data pertaining to the patent/patent application field:

TABLE 1
An example intermediate data.

| | | Technology |
|---|---|---|
| Description | Claims | classification |
| The patent relates to | A image processing | H04N1 |
| an image processing | method comprising: . . . | |
| method . . . | | |
| The patent relates to | A lens assembly | G03B5 |
| a lens assembly . . . | comprising: . . . | |
| The patent relates to | A heater | H03B |
| a heater for car | comprising: . . . | |
| windshield . . . | | |

Referring to table 1, the term “H03B”, “G03B5”, and “H04N1” corresponds to the technology classification associated with the one or more phrases illustrated in the description and the claims. In some examples, the text and the corresponding technology classification is mentioned for exemplary purposes and the scope of the disclosure should not be limited to the table 1. In an example embodiment, the content of the table 1 may vary based on the application area.

Subsequently, the training unit 208 may be configured to define one or more features and the one or more labels in the intermediate data. As discussed, the one or more features may correspond to the expected input to the ML model (to be trained) and the one or more labels may correspond to the expected output of the ML model (to be trained). For example, the training unit 208 may be configured to define the description and the claims as the one or more features and the technology classification as the one or more labels. Training unit 208 may consider the intermediate data, having the defined one or more labels and the defined one or more features, as the training data.

In an example embodiment, the training unit 208 may be configured to train the ML model. To train the ML model, the training unit 208208 may be configured to remove unwanted words and/or phrases, from each of the one or more features, corresponding to a label, to generate one or more clean features. For example, the training unit 208 may be configured to remove the unwanted words and/or phrases from the one or more phrases included in the claims and description corresponding to the technology field “H03B”. Similarly, the training unit 208 may be configured to remove the unwanted words and/or phrases from the one or more features corresponding to other technology fields. Such unwanted words and/or phrases may be referred to as stop words. In some examples, the stop words may include words that are insignificant and do not add meaning to the one or more phrases included in the one or more features of the training data. Some examples of the stop words may include, but are not limited to, “is”, “are”, “and”, “at least”, and/or the like. Thereafter, in some examples, the training unit 208 may be configured to identify n-grams in the one or more phrases included in each of the one or more clean features corresponding to each of the one or more labels. N-gram corresponds to combination of two or more words in a phrase (for example each of the one or more phrases included in the each of the one or more clean features) that are used in conjunction. For example, the term “user” and “interface” are often used together. Accordingly, the training unit 208 may be configured to identify the term “user interface” as an N-Gram. In an exemplary embodiment, the training unit 208 may be configured to add the identified n-gram to the one or more clean features to create a training corpus for each of the one or more labels. For example, the training unit 208 may be configured to create the training corpus for each technology classification.

Thereafter, the training unit 208 may be configured to train the ML model using the training corpus created for each of the one or more labels, and the one or more labels, itself. In some examples, training the ML model using the training corpus may include converting the words in training corpus in one or more vectors. In some examples, the one or more vectors correspond to the words may correspond to one or more characteristics of the words within the training corpus. For example, the one or more characteristics may include, but not limited to, a frequency occurrence of a word within the training corpus, one or more words with which a word is usually used, and/or the like. Thereafter, the training unit 208 may be configured to train a neural network using the one or more vectors. The trained neural network corresponds to the ML model. Those skilled in the art would appreciate that scope of the disclosure is not limited to using the neural network as the ML model. In an exemplary embodiment, the ML model may be realized using other techniques such as, but not limited to, logistic regression, Bayesian regression, random forest regression, and/or the like.

Additionally or alternatively, the training unit 208 may be configured to create the vocabulary database based on the training corpus created for each of the one or more labels. In an example embodiment, the training unit 208 may be configured to utilize one or more known methods such as, but are not limited to, word2vec, bag of words, sentence2vec, and/or the like to create the vocabulary database for each of the one or more labels. In some examples, the vocabulary database may include a collection of words that are semantically similar in the one or more phrases included in the one or more clean features of the training data.

In an example embodiment, the first processor 202 may be configured to receive the text input from the computing device 104. As discussed, the text input is in the native English language. Upon receiving the text input, the prediction unit 210 may be configured to utilize the ML model to convert the text input into the one or more vectors. In an example embodiment, the string vector may correspond to an array of integers, where each integer in the string vector may correspond to a characteristic of one or more phrases in the text input (received from the computing device). For example, the text input received from the computing device 104 recites “a mobile device that includes a camera, where the camera is used to capture images”. In such an embodiment, the string vector may include the integer “2”, which may represent the frequency of the term “camera” in the text input.

Thereafter, the prediction unit 210 may be configured to input the search vector to the ML model (that was trained using the training data) to predict the technology classification associated with the text input. In some examples, the scope of the disclosure is not limited to predicting only single technology classification associated with the text input. In an example embodiment, the prediction unit 210 may be configured to predict a plurality of technology classifications associated with the text input. In such an embodiment, the prediction unit 210 may be configured to determine a confidence score associated with each of the plurality technology classifications, predicted by the prediction unit 210. Thereafter, the prediction unit 210 may be configured to select one or more technology classifications from the plurality technology classification based on the confidence score associated with each of the plurality of technology classifications. For example, the prediction unit 210 may be configured to select the one or more technology classifications that a confidence score greater than a predetermined confidence threshold. For instance, the confidence threshold is 80%, the prediction unit 210 may be configured to select the one or more technology classifications having confidence score greater than 80%.

Concurrently, the prediction unit 210 may be configured to retrieve one or more phrases from the text input. In an example embodiment, the one or more phrases may correspond to noun phrases, nouns, and/or verbs in the text input. In some examples, the noun phrase may include a combination of the nouns and verbs that in conjunction may represent a noun in the text input. The nouns and the verbs included in the noun phrase may have independent meanings, however, the noun and verb, in conjunction, may have a separate meaning than the independent meanings of the noun and the verb. In some examples, the nouns and verbs in the noun phrase may be positioned adjacent to each other in the text input. For example, the term “user interface” (in the text input) may correspond to the noun phrase, where both the terms in the noun phrase “user” and “interface” have independent meanings. Further, the terms, when used in conjunction, may also have a meaning that may be different from the independent meanings of the terms.

Additionally or alternatively, the prediction unit 210 may be configured to determine the set of words for each of the one or more phrases using the vocabulary database associated with each of the one or more technology classifications. More particularly, the prediction unit 210 may be configured to determine the set of words for each word in the one or more phrases using the vocabulary database associated with each of the one or more technology classifications. As discussed, each of the plurality of technology classifications has an associated vocabulary database. Accordingly, the prediction unit 210 may be configured to determine the set of words based on vocabulary database associated with each of the one or more technology classifications.

In some examples, the set of words, determine for each word in the one or more phrases, may correspond to the synonyms of the each word in the one or more phrases. In an example embodiment, the first processor 202 may be configured to transmit the one or more technology classifications, the one or more phrases and the set of words associated with word in the one or more phrases to the computing device 104.

In an alternate embodiment, the first processor 202 may be configured to generate one or more structured search strings based on the technology classification, the one or more phrases, and the set of words. Following sections generation of different structured search string:

### Generation of First Structured Search String

In an exemplary embodiment, the first processor 202 may be configured to retrieve a phrase of the one or more phrases. Thereafter, the first processor 202 determines whether the phrase includes a plurality of words. If the phrase includes the plurality of words, the first processor 202 may be configured to determine a distance between each pair of words in the phrase. In an exemplary embodiment, the distance between the pair of words may correspond to a count of words between the pair of words in the phrase. For example, if the phrase is “image processing device”, the first processor 202 may be configured to determine the words “image” and “processing”, in the phrase, as the pair of words. Additionally, the first processor 202 may be configured to determine the distance between the pair of words “image” and “processing” as one. Further, the distance between the word “processing” and “device” is one. Thereafter, the first processor 202 may be configured to determine a first structured search string operator based on the determined distance between each of the plurality of words in the phrase. For example, for the pair of the adjacent words, the first processor 202 may be configured to determine the first structured search string operator as “1D”, where “1” corresponds to the determined distance between the pair of words and “D” corresponds to a phrase that is defined based on the database to be addressed using the structured search string. For example, the phrase “D” is defined for Orbit database. In some examples, “D” is replaced with “near” for “Derwent innovation” database. In some examples, the first structured search string operator “1D” may instruct the database 108 to retrieve the patent/patent application documents that contains the pair of words (separated by the first structured search string operator) and are positioned at most at a distance indicated by the numeral included in the first structured search string operator. For example, if the first structured search string operator is “2D”, the first structured search string operator may instruct the database 108 to retrieve the patent/patent application documents that includes the pair of words (separated by the first structured search string operator) positioned at a distance of at most “2”.

In some examples, the scope of the disclosure is not limited to generating the first structured search string operator based on the determined distance between the pair of words. Additionally or alternatively, the first processor 202 may determine the first structured search string operator based on the coverage of the structured search string to be generated. In an exemplary embodiment, the coverage of the structured search string may be defined by a count of patent/patent application documents that comprises the pair of words separated by the distance deterministic from the first structured search string operator. For example, the first structured search string operator “1D” has less coverage that the first structured search string operator “2D”. To this end, the first processor 202 may receive an input from the computing device 104 to define the coverage of the structured search string in addition to the search string. In an example embodiment, the coverage of the structured search string may comprise “narrow”, “broad”, and “broadest”. Thereafter, the first processor 202 may be configured to determine the first structured search string operator based on the coverage. For example, the first processor 202 may utilize a following look-up table to determine the first structured search string operator:

TABLE 2
Look-up table to determine first structured search string operator.

| Coverage | Numeral of the first structured search string operator |
|---|---|
| Narrow | Use the determined distance to determine the first |
| | structured search string operator |
| Broad | Determined distance + 3 |
| Broadest | Determined distance + 5 |

In some examples, the scope of the disclosure is not limited to the first processor 202 using the look-up table, as illustrated in table 2, to determine the first structured search string operator. In an example embodiment, the look-up table may include the other values without departing from the scope of the disclosure. Further, the scope of the disclosure is not limited to the coverage of the structured search string may comprising only “narrow”, “broad”, and “broadest”. In an example embodiment, the coverage may include more than three scopes. To this end, the look-up table may include additional rows for the additional scopes.

In yet another embodiment, the scope of the disclosure is not limited to using the look-up table to determine the first structured string operator. In an exemplary embodiment, the based on the coverage of the first structured search string, the first processor 202 may be configured to add a predetermined distance to the determined distance between the pair of words. For example, the determined distance between the pair of words is 3 and the coverage of the structured search string to be generated is broad, the first processor 202 may be configured to add predetermined distance of “3” to the determined distance. To this end, the first processor 202 may be configured to determine the first structured string operator as “6D”. Following table illustrates a mapping between the predetermined distance and the coverage of the structured search string.

TABLE 2
Mapping between predetermined distance and the
coverage of the structured search string

| Coverage | Predetermined distance |
|---|---|
| Narrow | 0 |
| Broad | 3 |
| Broadest | 5 |

Additionally or alternatively, the first processor 202 may be configured to generate a first portion of the structured search string. In an example embodiment, the first processor 202 may be configured to add the first structured string operator between the pair of adjacent words. For example, if the pair of adjacent words include “image processing” and the determined first structured string operator is “3D”, the first processor 202 may be configured to generate the first portion of the structured search string as “image 3D processing”.

In some examples, the scope of the disclosure is not limited to using the pair of adjacent words as it is, in the first portion of the structured search string. In an example embodiment, prior to generating the first portion of the structured search string, the first processor 202 may be configured to stem the pair of adjacent words. In some examples, the stemming a word may correspond to a process in which the word is converted to a base form. For example, the first processor 202 may convert the word “processing” to “process” after the stemming operation. In such an embodiment, the word “process” may correspond to the base word of the word “processing”. Similarly, the first processor 202 may be configured to stem the pair of adjacent words to generate the pair of adjacent stemmed words. Thereafter, the first processor 202 may be configured to add a predetermined suffix to the pair of adjacent stemmed words. For example, the first processor 202 may be configured add the suffix “+” to each of the pair of adjacent stemmed words. Subsequently, the first processor 202 may be configured to add the first structured string operator between the pair of adjacent stemmed words. For example, if the pair of adjacent words include “image processing” and the determined first structured string operator is “3D”, the first processor 202 may be configured to firstly generate the pair of adjacent stemmed words as “imam+” and “process+”. Thereafter, the first processor 202 may be configured to add the first structured string operator “3D” between the pair of adjacent stemmed words to generate the first portion of the structured search string as “imag+ 3D process+”.

Similarly, the first processor 202 may be configured to generate the first portion of the structured search string using other pair of adjacent words in the phrase. For example, the first processor 202 may be configured to determine the first portion of the structured string as “process+ 3D devic+”, Thereafter, the first processor 202 may be configured to combine the first portion of the structured search string, generated for each pair of adjacent words in the phrase” to generate the combined first portion of the structured search string. In some examples, the first processor 202 may be configured to combine the first portion of the structured search string in a manner that words are not repeated. For example, the first processor 202 may combine the portion of structured search string “imag+ 3D process+” and the portion of structured search string “process+ 3D devic+” to generated the combined first portion of the structured search string as “image+ 3D process+ 3D devic+”.

Additionally, the first processor 202 may be configured to add the set of words determined, for each word in the phrase, to the combined first portion of the structured search string. In some examples, prior to adding the set of words, determined for each word in the phrase, the first processor 202 may be configured to stem each word in the set of words. Thereafter, the first processor 202 may be configured to add the set of words to the combined first portion of the structured search string. For example, the first processor 202 may be configured to append the set of words corresponding to the word “image” to the word “image+” in the combined first portion of the structured search string. Additionally or alternatively, the each of the set of words associated with the word in the phrase, and the word itself are separated by a logical operator “OR”. For example, the set of words determined for the word “image” includes “picture”, “pixel”, “video”, and or the like. Accordingly, the first processor 202 may be configured to append the set of words (determined for the word “image) to the word “image” in the combined first portion of the structured search string, and may further separate each word in the set of words with the logical operator “OR” to create a modified first portion of the structured search string as “(image+ or picture or video or pixel) 3D process+ 3D devic+”. Similarly, the first processor 202 may be configured to append the set of words associated with other words in the phrase to generate the modified first portion of the structured search string. Additionally or alternatively, the first processor 202 may be configured to add parenthesis the modified first portion of the structured search string. For example, the first processor 202 may be configured to encapsulate the portion of the modified first portion of the structured search string, which are separated by the first structured search string operator, with parenthesis.

Similarly, the first processor 202 may be configured to determine the modified first portion of the structured search string for each of the one or more phrases.

If the processor 202 determines that the phrase includes a single word, the first processor 202 may skip the determination of the first structured search string operator. Further, the first processor 202 may configured to directly append the set of words to the single word and may separate the set of words and the single word, itself by the logical operator “OR”, as is described above.

In an example embodiment, the first processor 202 may be configured to determine distance between a pair of phrases in the one or more phrases. In some examples, the first processor 202 may be configured to determine distance between the pair of phrases of the one or more phrases using the methodology as is described above to determine the distance between pair of adjacent words in the phrase. As discussed, the determined distance between the pair of phrases may correspond to a count of words between the pair of phrases in the text input received from the computing device 104. Thereafter, in some examples, the first processor 202 may be configured to determine a second structured search string operator based on the determined distance between the pair of phrases in the one or more phrases. In some examples, the second structured search string may be similar to the first structured search string operator. For example, the first processor 202 may determine the second structured search string as “3D”, where 3 corresponds to the distance between the pair of phrases. Additionally or alternatively, the first processor 202 may be configured to determine whether the determined distance between the pair of phrases is greater than a first predetermined threshold. If the first processor 202 determines that the determined distance is greater than the first predetermined threshold, the first processor 202 may be configured to determine the second structured search string operator as “S”. In some examples, the structured search string operator “S” may signify that pair of phrases may be found in a single sentence of the patent/patent applications. However, if the first processor 202 determines that the determined distance between the pair of phrases is less than the first predetermined threshold, the first processor 202 may be configured to determine the second structured search string operator as “nD”, where “n” corresponds to the determined distance between the pair of phrases. Further, if the processor 202 determines that the determined distance between the pair of phrases is greater than a second predetermined threshold, the first processor 202 may be configured to determine the second structured search string operator as “P”. In some examples, the structured search string operator “P” may signify that pair of phrases may be found in a same paragraph of the patent/patent applications. In some examples, the first processor 202 may be configured to include the second structured search string operator between the modified first portion of the structured search string determined for each phrase in the pair of phrases to generate a second portion of the structured search string. For examples, the modified first portion of the structured search string corresponding to a first phrase in the pair of phrases is “image+ 3D process+” and the modified first portion of the structured search string for a second phrase in the pair of phrases is “pixel+”, the first processor 202 may append the second structured search string operator “S” between the “image+ 3D process+” and “pixel+” to generate the second portion of the structured search string. Additionally or alternatively, the first processor 202 may be configured to encapsulate, the modified first portion of the structured search string (determined for each of the one or more phrases), within parenthesis.

In an example embodiment, the first processor 202 may be configured to utilize similar methodology to generate second portion of structured search string for each pair of phrases. Thereafter, the first processor 202 may be configured to combine the second portion of the structured search string to generate a first structured search string. In some examples, the first processor 202 may be configured to combine the second portion of the structured search string in such a manner that the first portion of the structured search string is not repeated.

### Second Structured Search String

In an example embodiment, the first processor 202 may be configured to retrieve the vocabulary database associated with the technology classification determined for the text input. As discussed, the prediction unit 210 may be configured to determine technology classification based on the text input using the ML model. Further, as discussed, the technology classification has the associated vocabulary database. Accordingly, the first processor 202 may be configured to retrieve the vocabulary database associated with the technology classification. Further, the first processor 202 may be configured to determine a word cloud of the technology classification. In some examples, the word cloud includes a list of frequently used words in the patent/patent applications corresponding the technology classification.

Thereafter, the first processor 202 may be configured to determine an intersection between the one or more phrases and the words in the word cloud (retrieved from the vocabulary database). In some examples, based on the intersection between the one or more phrases and the word cloud, the first processor 202 to identify a second set of words that are common in the one or more phrases and the word cloud. Thereafter, the first processor 202 may be configured to remove a set of phrases from the one or more phrases such that the remaining phrases of the one or more phrases are devoid of the common words. For example, the word cloud includes the word “image” and “process”. Further, the one or more phrases includes a first phrase “image processing device” and a second phrase “pixel”. Accordingly, the first processor 202 may be configured to remove the phrase “image processing device” since the words “image” and “process” are common to the word cloud.

In an example embodiment, the first processor 202 may be configured to generate the first structured search string based on the remaining phrases, using the methodology described above. Thereafter, the first processor 202 may be configured to append the technology classification to the first structured search string such that the technology classification and the first structured search string is separated by a logical operator “AND”. To this end, the first structured search string with appended technology classification is referred to as second structured search string.

In another implementation, rather than generating the first structured search string using the remaining phrases, the first processor 202 may be configured to remove the common words from first structured search string and add the technology classification to the first structured search string (containing the remaining words) to generate the second structured search string.

In some examples, where the first processor 202 identifies more than one technology classification, the first processor 202 may be configured to generate multiple second structured search strings for each technology classification based on the methodology described above.

In some examples, the scope of the disclosure is not limited to determine the word cloud for each of the one or more technology classifications. In an example embodiment, the first processor 202 may be configured to determine frequent words for each of the one or more technology classifications based on the vocabulary database associated with each of the one or more technology classifications. Based on the frequent words, the first processor 202 may be configured to generate the second structured search string based on the methods described above in conjunction with word cloud associated with each of the one or more technology classifications.

### Third Structured Search String

In an example embodiment, the first processor 202 may be configured to determine word cloud for each of the one or more technology classifications. In some examples, the first processor 202 may be configured to utilize the vocabulary database associated with the first processor 202 to determine the word cloud for each of the one or more technology classification. Thereafter, the first processor 202 may be configured to determine a similarity score amongst the word cloud for each of the one or more technology classifications. In some examples, the first processor 202 may be configured to utilize one or more known technologies such as cosine similarity, Pearson coefficient, Euclidean distance, and/or the like.

In an example embodiment, the first processor 202 may be configured to compare the similarity score with a similarity score threshold to identify one or more sets of technology classifications in the one or more technology classifications. In an example embodiment, each of the one or more sets of technology classifications include technology classifications that are similar to each other. Further, the one or more sets of technology classifications are dissimilar amongst each other. For example, a first technology classification in the first set of technology classification (in the one or more sets of technology classifications) is dissimilar from the second technology classification in the second set of technology classification.

Thereafter, the first processor 202 may be configured to generate the third structure search string based on the first set of technology classifications and the second set of technology classifications. For example, the first processor 202 may be configured to separate each technology classification in the first set of technology classifications by logical operator “OR” to generate a first portion of the third structure search string. Further, the first processor 202 may be configured to separate each technology classification in the second set of technology classifications by logical operator “OR” to generate second portion of the third structured search string. Additionally, the first processor 202 may be configured to append the first portion of third structured search string with the second portion of third structured search string by including the logical operator “AND” between the first portion of third structured search string with the second portion of third structured search string to generate the third structured search string. In some examples, the scope of the disclosure is not limited to creating first set of technology classifications and the second set of technology classifications. In an example embodiment, the first processor 202 may be configured to generate the third structured search string that includes other set of technology classifications of the one or more sets of technology classifications.

In an example embodiment, the first structured search string, the second structured search string, and the third structured search string in conjunction, may be referred to as search strategy corresponding to the text input.

In some examples, the scope of the disclosure is not limited to determine the word cloud for each of the one or more technology classifications. In an example embodiment, the first processor 202 may be configured to determine frequent words for each of the one or more technology classifications based on the vocabulary database associated with each of the one or more technology classifications. Based on the frequent words, the first processor 202 may be configured to generate the third structured search string based on the methods described above.

In some examples, after the generation of the search strategy (that includes the first structured search string, the second structured search string, and third structured search string), the first processor 202 may be configured to query the database to retrieve relevant patent/patent applications. The patent/patent applications retrieved from the database based on the search strategy are relevant to the search string (i.e., the text input). In another example, the first processor 202 may be configured to transmit the search strategy to the computing device 104, where the computing device 104 may present the search strategy to the user.

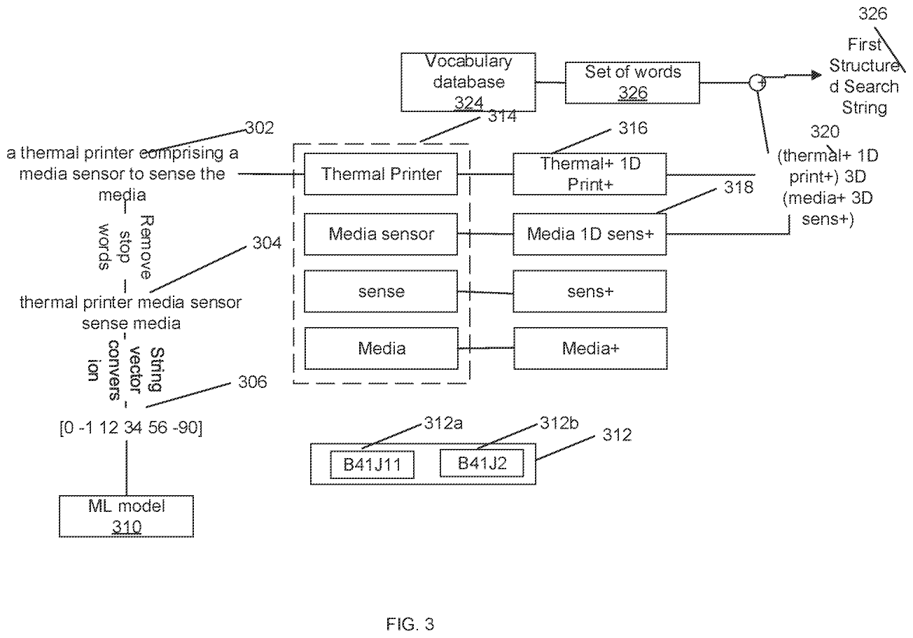

FIG. 3 illustrates a flow diagram 300 of an example scenario, according to one or more embodiments illustrated herein.

The first processor 202 receives the text input 302. For example, the text input 302 states “a thermal printer comprising a media sensor to sense the media.”. The prediction unit 210 may be configured to remove the stop words from the text input 302. For example, the prediction unit 210 may be configured to remove “comprising”, “a”, “to”, and “the” to generate modified text input “thermal printer media sensor sense media” (depicted by 304). Additionally, the prediction unit 210 may be configured to convert the modified text input 304 into a string vector 306. As discussed, the string vector 306 may correspond to an array of vectors [0 −1 12 34 56 −90]. Thereafter, the prediction unit 210 may be configured to input the string vector 306 into the ML model 310 to predict the one or more technology classifications 312. For examples, the one or more technology classifications may include “B41J11” (depicted by 312a) and “B41J2” (depicted by 312b).

Additionally or alternatively, the prediction unit 210 may be configured to retrieve one or more phrases 314 from the modified text input based on the methods described in FIG. 2. For example, the prediction unit 210 may be configured to determine the one or more phrases “thermal printer”, “media sensor”, “sense”, and “media”. Thereafter, the first processor 202 may be configured to determine the first structured search string operator based on distance plurality of words in a phrase. For example, the first processor 202 may be configured to determine the structured search string operator for the words “thermal” and “printer” as “1D”. Similarly, the first processor 202 may be configured to determine the first structured search string operator for the plurality of words in the other phrases in the one or more phrases 314. For example, the first processor 202 may be configured to determine the first structured search string operator as “1D” for the words “media” and “sensor”.

Additionally, the first processor 202 may be configured to generate the first portion of the structured search string by placing the first structured string operator between the pair of adjacent words. For example, the first processor generates the first portion of the structured search string as “thermal 1D printer” (depicted by 316). For each pair of words in the each of the one or more phrases, the first processor 202 may be configured to generate the first portion of the structured search string. To this end, the first processor 202 may be configured to generate the first portion of the structured search string “media 1D sensor” (depicted by 318). Additionally or alternatively, the first processor 202 may be configured to stem the words in the first portion of structured search string and append the stemmed words with an operator “+” to generate first portion of the structured search string. To this end, the first portion of the structured search string may state “thermal+ 1D print+”

Thereafter, the first processor 202 may be configured to determine the second structured search string operator for the one or more phrases. For example, the first processor 202 may be configured to determine the second structured search string operator for each pair of phrases in the one or more phrases. In some examples, the first processor 202 may be configured to determine the second structured search string operator based on the distance between the pair of phrases of the one or more phrases in the text input. For example, the first processor 202 may be configured to determine the second structured search string operator as “3D” between the phrase “thermal printer” and the phrase “media sensor”. Accordingly, the first processor 202 may be configured to place the second structured search string operator between the first portion of the structured search strings (generated for the pair of words in the one or more phrases) corresponding to the one or more phrases, to generate second portion of the structured search string. For example, the first processor 202 may generate the second portion of the structured search string as “(thermal+ 1D print+) 3D (media+ 3D sens+)” (depicted by 320). The parenthesis is added based on the methodology described in conjunction with FIG. 2.

Additionally or alternatively, the first processor 202 may be determine the set of words 322 for each word in the second portion of the structured search string 320 based on the vocabulary database 324 associated with the one or more technology classifications 312 (identified by the prediction unit 210 based on the text input). As discussed, the set of words 322 corresponds to the synonyms of the words in the second portion of the structured search string 320. Further, the first processor 202 may be configured to stem the set of words.

Additionally or alternatively, the first processor 202 may be configured to append the set of words to the second portion of the structured search string 320. For example, the first processor 202 may be configured to append the set of words to each word, in the second portion of the structured search string 320. As discussed, the set of words corresponds to synonyms of the each word in the second portion of the structured search string 320. Appending the set of words includes placing the logical operator “OR” between the set of words and corresponding word. Accordingly, the first processor 202 generates the first structured search string 326. For example, the first structured search string states “(((thermal+ or heat+ or temp+) 1D (print+ or reproduce+)) 3D ((media+ or paper+) 1D (sens+ or detect+)))”.

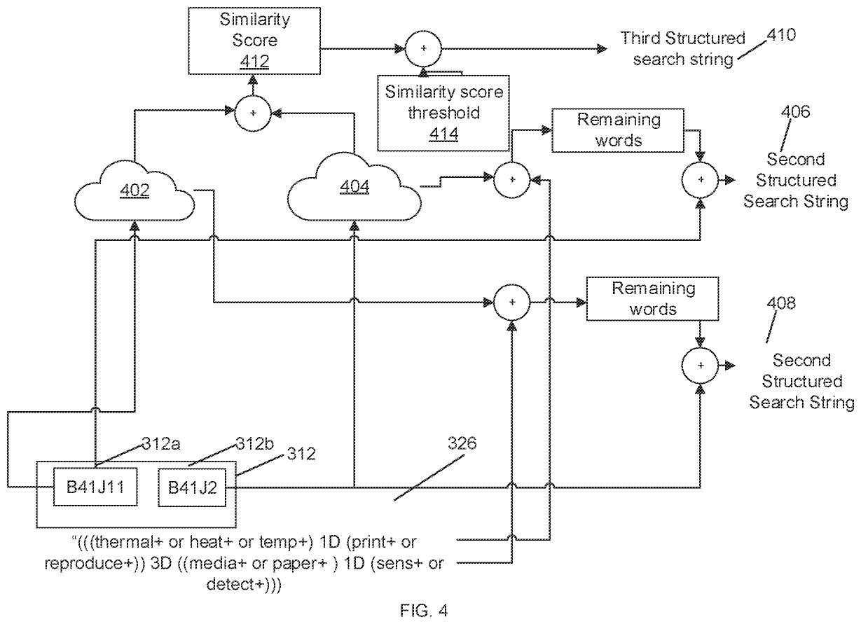

FIG. 4 illustrates another example scenario 400, according to one or more embodiments illustrated herein.

The example scenario 400 illustrates the one or more technology classifications “B41J11” (depicted by 312a) and “B41J2” (depicted by 312b). Further, the example scenario 400 illustrates first structured search string states “(((thermal+ or heat+ or temp+) 1D (print+ or reproduce+)) 3D ((media+ or paper+) 1D (sens+ or detect+)))” (depicted by 326). The first processor 202 may be configured to generate the first word cloud 402 based on the vocabulary database associated with the technology classification “B41J11” 312b. For example, the first word cloud 402 includes the second set of words. For example, the second set of words include “thermal”, “printer”, “temperature”, and/or the like. Further, the second processor 202 may be configured to generate the second word cloud 404 for the technology classification “B41J3” (depicted by 312a) that includes the second set of words. For example, the second set of words for the technology classification “B41J3” (depicted by 312a) includes “media”, and “paper”.

In some examples, the first processor 202 may be configured to determine an intersection between the words in the first structured search string 326 and the word clouds 402 and 404 to determine common words. For example, based on the intersection between the first structured search string 326 and the word cloud 402, the first processor 202 may determine the common words as “thermal: and “printers”. Subsequently, the first processor 202 may be configured to remove the common words and the corresponding the set of words (i.e., synonyms of the common words) from the first structured search string 326. Accordingly, the first structured search string 326 includes remaining words. Thereafter, the first processor 202 may be configured to append the technology classification “B41J11” (depicted by 312b) to the first structured search string 326 containing the remaining words to generate second structured search string 406. For example, the second search string 406 may state ““(B4011) AND ((media+ or paper+) 1D (sens+ or detect+)))”.

Similarly, the first processor 202 may be configured to generate another second structured search string 408 based on the word cloud 404 corresponding to the technology classification “B41J3” (depicted by 312a). For example, the second search string 408 states ““(((thermal+ or heat+ or temp+) 1D (print+ or reproduce+)) AND (B41J3)”.

Additionally, the first processor 202 may be configured to generate the third structured search string 410 based on the technology classification “B41J11” (depicted by 312a) and “B41J2” (depicted by 312b). For example, the first processor 202 may be configured to determine the similarity score 412 between the word clouds 402 and 404. For example, the first processor 202 determines a Cosine similarity between the word clouds 402 and 404. Thereafter, the first processor 202 compares the similarity score 412 with the similarity score threshold 414. If the similarity score exceeds the similarity score threshold 414, the first processor 202 may be configured to combine the technology classification “B41J11” (depicted by 312a) with “B402” (depicted by 312b) by appending logical operator “OR” between the “B41J11” (depicted by 312a) and “B41J2” (depicted by 312b). If the similarity score is less than the similarity score threshold 414, the first processor 202 may be configured to combine the technology classification “B41J11” (depicted by 312a) with “B41J2” (depicted by 312b) by appending logical operator “AND” between the “B41J11” (depicted by 312a) and “B402” (depicted by 312b). Such string corresponds to the third structured search string 414. In some examples, the first structured search string, the second structured search string, and the third structured search string corresponds to the search strategy corresponding to the text input.

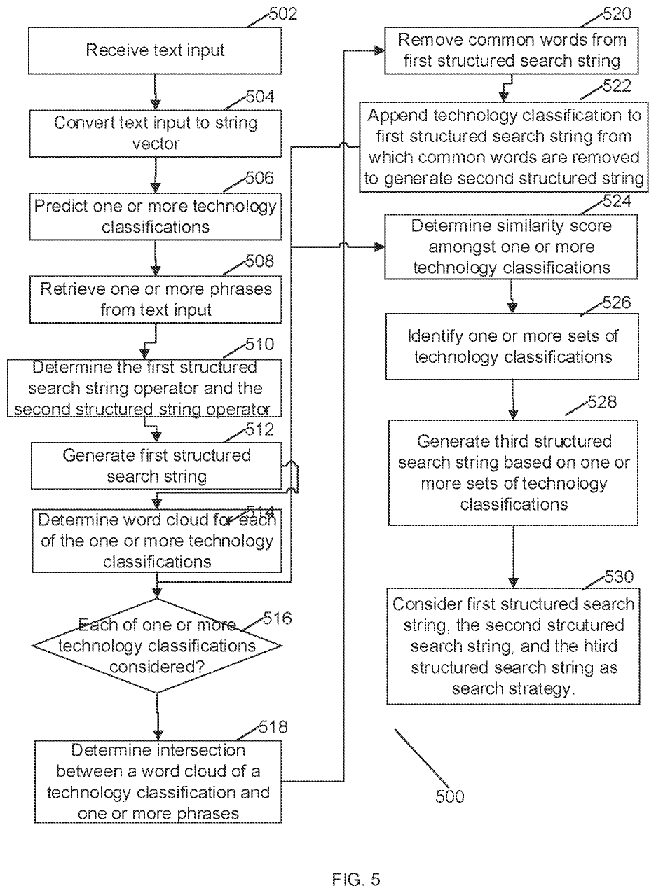

FIG. 5 illustrates a flowchart 500 of a method for operating the central server 102, according to one or more embodiments illustrated herein.

At 502, a text input is received. As discussed, the text input corresponds to a technical concept that a user wishes to search for the in the patent/patent applications. In an example embodiment, the first processor 202 may be configured to receive the text input. At 504, the text input is converted to string vector. In an example embodiment, the prediction unit 210 may be configured to convert the text input to the string vector. At 506, the one or more technology classifications associated with the text input are predicted. In an example embodiment, the prediction unit 210 may be configured to predict the one or more technology classifications based on the string vector.

At 508, the one or more phrases are retrieved from the text input. In an example embodiment, the first processor 202 may be configured to retrieve the one or more phrases from the text input. At 510, the first structured search string operator and the second structured string operator are determined based on the distance between the one or more words in each of the one or more phrases, and the distance between each of the one or more phrases in the text input, respectively. In an example embodiment, the first processor 202 may be configured to determine the first structured search string operator and the second search string operator. At 512, the first structured search string is generated based on the first structured search string operator and the second search string operator. In an example embodiment, the first processor 202 may be configured to generate the first structured search string. At 514, the word cloud is determined for each of the one or more technology classifications. In an example embodiment, the first processor 202 may be configured to determine the word cloud for each of the one or more technology classifications based on the vocabulary database associated with each of the one or more technology classifications. At 516, a check is performed to determine whether each of the one or more technology classifications has been considered. In an example embodiment, the first processor 202 may be configured to perform the check. If the first processor 202 determine that each of the one or more technology classifications has been considered, 524 is performed. However, if the first processor 202 determine that each of the one or more technology classifications has not been considered, 518 is performed.

At 518, intersection between the one or more phrases and a word cloud associated with a technology classifications of the one or more technology classifications is determined to identify common words in the one or more phrases and the word cloud. In an example embodiment, the first processor 202 may be configured to determine the intersection between the one or more phrases and the word cloud. At 520, the common words are removed from the first structured search string. In an example embodiment, the first processor 202 may be configured to remove the common words from the first structured search string. At 522, the technology classification is appended to the first structured search string from which the common words are removed to generate second structured string. In an example embodiment, the first processor 202 may be configured to append the technology classification to the first structured search string from which the common words are removed. Thereafter, 516 is repeated.

At 524, the similarity score amongst the one or more technology classifications is determined. In an example embodiment, the first processor 202 may be configured to determine the similarity score. At 526, based on the similarity score, one or more sets of technology classifications are identified. Each set of technology classifications includes similar technology classifications. In an example embodiment, the first processor 202 may be configured to determine the one or more set of technology classifications. At 528, the third structured search string is generated based on the one or more sets of technology classifications. In an example embodiment, the first processor 202 may be configured to generate the third structured search string. At 530, the first structured search string, the second structured search string, the third structured search string are considered as the search strategy.

In some examples, the scope of the disclosure is not limited to performing the steps in the order as is described in FIG. 5. In an example embodiment, the processor 202 may be configured to determine the first structured search string, the second structured search string, and the third structured search string in any order, or in parallel, without departing from the scope of the disclosure.

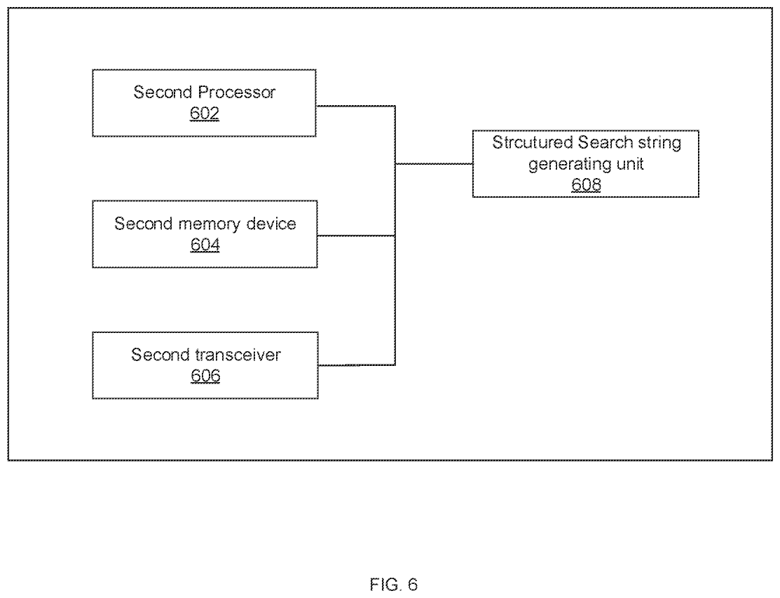

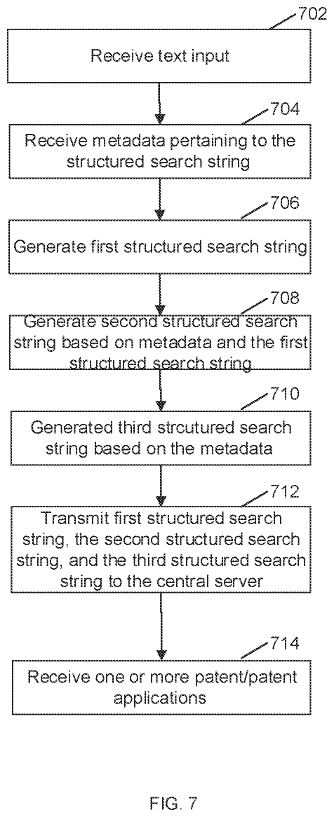

In some examples, the scope of the disclosure is not limited to the central server 102 generating the search strategy. In an example embodiment, the computing device 104 may be configured to generate search strategy, without departing from the scope of the disclosure. FIGS. 6 and 7 describe generation of the search strategy by the computing device 104.

FIG. 6 illustrates a block diagram of the computing device 104, according to one or more embodiments illustrated herein. The computing device 104 includes a second processor 602, a second memory device 604, a second transceiver 606, and a structured search string generator unit 608. The second processor 602 may be embodied as one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit (ASIC) or field programmable gate array (FPGA), or some combination thereof.

Accordingly, although illustrated in FIG. 6 as a single controller, in an exemplary embodiment, the second processor 602 may include a plurality of processors and signal processing modules. The plurality of processors may be embodied on a single electronic device or may be distributed across a plurality of electronic devices collectively configured to function as the circuitry of the computing device 104. The plurality of processors may be in communication with each other and may be collectively configured to perform one or more functionalities of the circuitry of the computing device 104, as described herein. In an exemplary embodiment, the second processor 602 may be configured to execute instructions stored in the second memory device 604 or otherwise accessible to the second processor 602. These instructions, when executed by the second processor 602, may cause the circuitry of the computing device 104 to perform one or more of the functionalities, as described herein.

Whether configured by hardware, firmware/software methods, or by a combination thereof, the second processor 602 may include an entity capable of performing operations according to embodiments of the present disclosure while configured accordingly. Thus, for example, when the second processor 602 is embodied as an ASIC, FPGA or the like, the second processor 602 may include specifically configured hardware for conducting one or more operations described herein. Alternatively, as another example, when the second processor 602 is embodied as an executor of instructions, such as may be stored in the second memory device 604, the instructions may specifically configure the second processor 602 to perform one or more algorithms and operations described herein.

Thus, the second processor 602 used herein may refer to a programmable microprocessor, microcomputer or multiple processor chip or chips that may be configured by software instructions (applications) to perform a variety of functions, including the functions of the various embodiments described above. In some devices, multiple processors may be provided that may be dedicated to wireless communication functions and one processor may be dedicated to running other applications. Software applications may be stored in the internal memory before they are accessed and loaded into the processors. The processors may include internal memory sufficient to store the application software instructions. In many devices, the internal memory may be a volatile or nonvolatile memory, such as flash memory, or a mixture of both. The memory can also be located internal to another computing resource (e.g., enabling computer readable instructions to be downloaded over the Internet or another wired or wireless connection).

The second memory device 604 may include suitable logic, circuitry, and/or interfaces that are adapted to store a set of instructions that is executable by the second processor 602 to perform predetermined operations. Some of the commonly known memory implementations include, but are not limited to, a hard disk, random access memory, cache memory, read only memory (ROM), erasable programmable read-only memory (EPROM) & electrically erasable programmable read-only memory (EEPROM), flash memory, magnetic cassettes, magnetic tape, magnetic disk storage or other magnetic storage devices, a compact disc read only memory (CD-ROM), digital versatile disc read only memory (DVD-ROM), an optical disc, circuitry configured to store information, or some combination thereof. In an exemplary embodiment, the second memory device 604 may be integrated with the second processor 602 on a single chip, without departing from the scope of the disclosure.

The second transceiver 606 may correspond to a communication interface that may facilitate transmission and reception of messages and data to and from various devices (e.g., computing device 104). Examples of the second transceiver 606 may include, but are not limited to, an antenna, an Ethernet port, a USB port, a serial port, or any other port that can be adapted to receive and transmit data. The second transceiver 606 transmits and receives data and/or messages in accordance with the various communication protocols, such as, Bluetooth®, Infra-Red, I2C, TCP/IP, UDP, and 2G, 3G, 4G or 6G communication protocols.

The structured search string generator unit 608 may include suitable logic and/or circuitry that may enable the structured search string generator unit 608 to receive metadata associated with the structured search string from the central server 102. As discussed, the metadata associated with the structured search string includes the one or more technology classifications, the one or more phrases, and the set of words (i.e., synonyms of the words in the one or more phrases). Based on the metadata, the structured search generator unit 608 may be configured to generate the search strategy. In some examples, the search strategy includes the first structured search string, the second structured search string, the third structured search string. The structured search string generator unit 608 may be implemented using Field Programmable Gate array (FPGA) and/or Application Specific Integrated Circuit (ASIC).

In operation, the second processor 602 may be configured to receive text input correspond to the search string. The second processor 202 may be configured to transmit the text input to the central server 102. Thereafter, in response to the transmission of the text input, the second processor 202 may be configured to receive the metadata associated with the structured search string from the central server 102. As discussed, the metadata includes the one or more technology classifications, the one or more phrases, and the set of words (i.e., synonyms of the words in the one or more phrases). The structured search string generator unit 608 generates the first structured search string based on the methodology, as is described above in FIG. 2. For example, the structured search string generator unit 608 may determine a distance between words in a phrase of the one or more phrase (received in the metadata), as is described above in FIG. 2. Thereafter, the structured search string generator unit 608 may be configured to determine the first structured search string operator based on the determined distance, as is described in FIG. 2. Further, the structured search string generator unit 608 may generate the first structured search string based on the first structured search string operator and the words in the phrase. Additionally or alternatively, the structured search string generator unit 608 may be configured to append the set of words (i.e., the synonyms of the words in the phrase) to the first structured search string.

In some examples, the structured search string generator unit 608 may be configured to query the vocabulary database associated with the one or more technology classifications to receive the word cloud. Thereafter, the structured search string generator unit 608 may be configured to determine the intersection between the one or more phrases and the word cloud associated with a technology classification of the one or more technology classification. As discussed, the intersection between the one or more phrases and the word cloud facilitates determination of the common words. Thereafter, the structured search string generator unit 608 may be configured to remove the common words from the first structured search string and may be configured to add the technology classification to the first structured search string. The structured search string so formed may correspond to the second structured search string.

In some examples, the structured search string generator unit 608 may be configured determine the similarity score amongst the one or more technology classifications, as is described in FIG. 2. Based on the similarity score, the structured search string generator unit 608 may be configured to identify one or more sets of technology classifications that include technology classifications that are similar to each other. Based on the one or more sets of technology classifications, the structured search string generator unit 608 may be configured to generate the third structured search string. In an example embodiment, the structured search string generator unit 608 may be configured to consider the first structured search string, the second structured search string, and the third structured search string as search strategy.

FIG. 7 illustrates a flowchart 700 of a method for operating the computing device 104, according to one or more embodiments illustrated herein. At 702, a text input pertaining to the search string is received. In an example embodiment, the second processor 602 is configured to receive the text input. Further, the second processor 602 transmit the text input to the central server 102. At 704, metadata pertaining to the structured search string is received from the central server 102. In an example embodiment, the second processor 602 may be configured to the receive the metadata pertaining to the structured search string. At 706, the first structured search string is generated based on the metadata pertaining to the structured search string. In an example embodiment, the structured search string generator unit 608 is configured to generate the first structured search string. At 708, the second structured search string is generated based on the metadata pertaining to the structured search string and the first structured search string. In an example embodiment, the structured search string generator unit 608 is configured to generate the second structured search string. At 710, the third structured search string is generated based on the metadata pertaining to the structured search string. In an example embodiment, the structured search string generator unit 608 is configured to generate the third structured search string. In some examples, the structured search string generator unit 608 may be configured to generate the third structured search string based on the one or more technology classifications. At 712, the first structured search string, the second structured search string, and the third structured search string (i.e., the search strategy) are transmitted to the central server 102. At 714, in response to the transmission of the search strategy, the one or more patent/patent applications are received from the central server 102. In an example embodiment, the second processor 602 may be configured to receive the one or more patents/patent applications. In some examples, the one or more patents/patents applications may be relevant to the text input provided by user.

In some examples, the scope of the disclosure is not limited to the central server 102 and/or computing device 104 generating the search strategy. In an example embodiment, the central server 102 and/or computing device 104 may be configured to modify the generated search strategy. In such an embodiment, the second processor 602 may be configured to present a user interface (UI) that may facilitate the user to modify the search strategy. For example, the user may provide the input to modify the first structured string operator, the second structured string operator, the set of words, and/or the like to modify the search strategy. In another embodiment, the UI may present a slider through which the user can input the scope of the search strategy. For example, the slider can be moved to define the scope of the search strategy. As discussed, the scope of the search strategy may be defined as “broad”, “narrow”, “medium”, and/or the like. Based on the movement of the slider to define the scope of the search strategy, the structured search string generator unit 608 may be configured to modify the first structured search string operator and the second structured search string operator. As discussed, the first structured search string operator and the second structured search string operator may be modified based on the one or more rules and/or the one or more look-up tables as illustrated with respect to the FIG. 2. The scope of the disclosure is not limited to using the slider on the UI to input the scope of the search strategy. In an example embodiment, the UI may include other input means such as an input field, a selection box, and/or the like to input the scope of the disclosure.

The foregoing method descriptions and the process flow diagrams are provided merely as illustrative examples and are not intended to require or imply that the operations of the various embodiments must be performed in the order presented. As will be appreciated by one of skill in the art, the operations may be performed in one or more different orders without departing from the various embodiments of the disclosure

The hardware used to implement the various illustrative logics, logical blocks, modules, and circuits described in connection with the aspects disclosed herein may include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, or in addition, some operations or methods may be performed by circuitry that is specific to a given function.

In one or more exemplary embodiments, the functions described herein may be implemented by special-purpose hardware or a combination of hardware programmed by firmware or other software. In implementations relying on firmware or other software, the functions may be performed as a result of execution of one or more instructions stored on one or more non-transitory computer-readable media and/or one or more non-transitory processor-readable media. These instructions may be embodied by one or more processor-executable software modules that reside on the one or more non-transitory computer-readable or processor-readable storage media. Non-transitory computer-readable or processor-readable storage media may in this regard comprise any storage media that may be accessed by a computer or a processor. By way of example but not limitation, such non-transitory computer-readable or processor-readable media may include RAM, ROM, EEPROM, FLASH memory, disk storage, magnetic storage devices, or the like. Disk storage, as used herein, includes compact disc (CD), laser disc, optical disc, digital versatile disc (DVD), floppy disk, and Blu-ray Disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media may be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the supply management system. Therefore, it is to be understood that the inventions are not to be limited to the specific embodiments disclosed and that modifications and other embodiments are intended to be included within the scope of the appended claims. Moreover, the operations in the method described above may not necessarily occur in the order depicted in the accompanying diagrams, and in some cases one or more of the operations depicted may occur substantially simultaneously, or additional operations may be involved. Although specific terms are employed herein, they are used in a generic and descriptive sense only and not for purposes of limitation.

1. A method comprising:
receiving, by a processor, a text input, wherein the text input corresponds to a search string;
converting the text input to a string vector;
retrieve, by the processor, one or more phrases in the text input;
predicting one or more technology classifications associated with the text input based on the string vector by utilizing a Machine Learning (ML) model; and
generating at least a first structured search string based on the one or more technology classifications and the one or more phrases.

2. The method of claim 1 further comprising determining a distance between each pair of words in each of the one or more phrases, wherein the distance corresponds to a count of words between the each pair of words.

3. The method of claim 2 further comprising determining a first structured search string operator based on the distance between the each pair of words, wherein the first structured search string generated based on the first structured search string operator.

4. The method of claim 1 further comprising determining a distance a pair of phrases, in the one or more phrases, in the text input, wherein the distance between the pair of phrases corresponds to a count of words between the pair of phrases.

5. The method of claim 4 further comprising determining a second structured search string operator based on the distance between the pair of phrases, wherein the first structured search string is generated based on the second structured search string operator.

6. The method of claim 1 further comprising determining a word cloud for each of the one or more technology classifications.

7. The method of claim 6 further comprising determining an intersection between one or more words in the one or more phrases, and the word cloud for a technology classification of the one or more technology classifications, to identify one or more common words.

8. The method of claim 7 further comprising:
removing the one or more common words from the first structured search string to generated modified first structured search string; and
appending the technology classification to the modified first structured search string to generate a second structured search string.

9. The method of claim 1 further comprising determining a similarity score amongst the one or more technology classifications.

10. The method of claim 9 further comprising identifying one or more sets of technology classifications based on the similarity score, wherein each of the one or more sets of technology classifications include a set of technology classifications that are similar to each other.

11. The method of claim 10 further comprises generating a third structured search string based on the one or more sets of technology classifications.

12. A central server comprising:
a memory device storing a set of instructions:
a processor communicatively coupled to the memory device, the processor is configured to execute the set of instructions to:
receive a text input, wherein the text input corresponds to a search string;
convert the text input to a string vector;
retrieve one or more phrases in the text input;
predict one or more technology classifications associated with the text input based on the string vector by utilizing a Machine Learning (ML) model; and
generate at least a first structured search string based on the one or more technology classifications and the one or more phrases.

13. The central server of claim 12, wherein the processor is further configured to determine a distance between each pair of words in each of the one or more phrases, wherein the distance corresponds to a count of words between the each pair of words

14. The central server of claim 13, wherein is further configured to determine a first structured search string operator based on the distance between the each pair of words, wherein the first structured search string generated based on the first structured search string operator.

15. The central server of claim 11, wherein the processor is further configured to determine a distance a pair of phrases, in the one or more phrases, in the text input, wherein the distance between the pair of phrases corresponds to a count of words between the pair of phrases.

16. The central server of claim 15, wherein the processor is further configured to determine a second structured search string operator based on the distance between the pair of phrases, wherein the first structured search string is generated based on the second structured search string operator.

17. The central server of claim 11, wherein the processor is further configured to determine a word cloud for each of the one or more technology classifications.

18. The central server of claim 17, wherein the processor is further configured to determine an intersection between one or more words in the one or more phrases, and the word cloud for a technology classification of the one or more technology classifications, to identify one or more common words.

19. The central server of claim 18, wherein the processor is further configured to:
remove the one or more common words from the first structured search string to generated modified first structured search string; and
append the technology classification to the modified first structured search string to generate a second structured search string.

20. The central server of claim 1, wherein the processor is further configured to determine a similarity score amongst the one or more technology classifications.

21. The central server of claim 9, wherein the processor is further configured to:
identify one or more sets of technology classifications based on the similarity score, wherein each of the one or more sets of technology classifications include a set of technology classifications that are similar to each other; and
generate a third structured search string based on the one or more sets of technology classifications.
